(19) United States
(12) Patent Application Publication
(10) Pub. No.: US 2009/0235518 A1
(43) Pub. Date: Sep. 24, 2009

(54) METHOD OF PRODUCING THIN FILM MAGNETIC HEAD

(75) Inventors: Takashi Ito, Kawasaki (JP); Hideaki Daimatsu, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/256,823

(22) Filed: Oct. 23, 2008

(30) Foreign Application Priority Data
Mar. 18, 2008 (JP) 2008-070090

(51) Int. Cl. G11B 5/147

(52) U.S. Cl. 29/603.07

(57) ABSTRACT

The method of producing a thin film magnetic head comprises the steps of: forming a recording head section by laminating thin films on a substrate; forming an air bearing surface in the recording head section; forming a coil layer on a base body of the recording head section; forming a first insulating layer on a coil wire of the coil layer and in a space defined by the coil wire other than a center part of the coil layer; forming an upper return yoke on the first insulating layer; forming a second insulating layer on the upper return yoke and the first insulating layer; flattening an upper face of the upper return yoke and an upper face of the second insulating layer so as to make the both faces as a continuous flat surface; and forming a low-thermal expansion material layer on the flat surface by sputtering.

### BACKGROUND OF THE INVENTION

The present invention relates to a method of producing a thin film magnetic head, more precisely relates to a method of producing a thin film magnetic head having a low-thermal expansion material layer.

These days, memory capacities of storing units, e.g., magnetic disk unit, have been significantly increased. Thus, improving performance of storage media and improving reproduction characteristics of magnetic heads are required. Reproducing heads including magnetoresistance effect elements, e.g., giant magnetoresistance (GMR) element capable of obtaining a high output power, tunneling magnetoresistance (TMR) element capable of obtaining high reproduction sensitivity, have been developed. On the other hand, induction type recording heads using electromagnetic induction have been developed. For example, a composite type thin film magnetic head, in which the above described reproducing head and recording head are combined, is now used.

To improve recording density of a magnetic disk unit, signal-to-noise ratio (S/N ratio) of reproducing signals of a magnetoresistance effect reproducing element must be highly increased by reducing an amount of floating a thin film magnetic head from a magnetic storage medium. However, in case of using the magnetic disk unit in a hot environment, projecting an air bearing surface of the thin film magnetic head becomes something of a problem with reducing the amount of floating the thin film magnetic head from the surface of the magnetic storage medium. The reason of causing the problem is that metallic parts and organic matters, e.g., resist, of the thin film magnetic head, whose thermal expansion coefficients are great, are expanded in the hot environment and, thus, they are not projected from a substrate, etc., whose thermal expansion coefficients are small, but projected from the air bearing surface. If the projection is significant, an end of the thin film magnetic head contacts the magnetic storage medium whereby the thin film magnetic head and/or the magnetic storage medium will be damaged. In an actual magnetic disk unit, the amount of floating the thin film magnetic head is great so as not to cause the contact in the hot environment. However, recording and reproducing characteristics of the thin film magnetic head will be worsened at the room temperature or in a cool environment, and recording density cannot be increased. Therefore, the projection must be prevented so as to highly increase the recording density of the magnetic disk unit.

A conventional thin film magnetic head capable of solving the problem of forming the projection, which is formed in an air bearing surface by heat expansion, is disclosed in Japanese Laid-open Patent Publication No. 2004-192665. The thin film magnetic head is shown in FIG. 18. The thin film magnetic head has: a reproducing section 111 for converting magnetic signals read from a magnetic storage medium into electric signals; a recording section 110 for writing magnetic signals in the magnetic storage medium; and a first protection film 130 being formed on the both sections 110 and 111. Further, a second protection film 131 is formed on the first protection film 130. A linear expansion coefficient of the second protection film 131 is smaller than that of the first protection film 130 so as to restrain said projection. The second protection film 131 is so-called “low-thermal expansion material layer”. Note that, a symbol 112 stands for a coil, symbols 114 and 115 stand for write-magnetic poles, a symbol 116 stands for a magnetic pole for defining a track width, a symbol 117 stands for an upper read-magnetic pole, a symbol 118 stands for an lower read-magnetic pole, a symbol 119 stands for a magnetoresistance effect film, a symbol 120 stands for an electrode, a symbol 124 stands for a base film, and a symbol 125 stands for a substrate.

Generally, the low-thermal expansion material layer is located possibly close to a metallic layer of the thin film magnetic layer, whose thermal expansion coefficient is great, so as to restrain said projection.

Another conventional thin film magnetic head having a low-thermal expansion material layer, which has been produced by the applicant of the present application, is shown in FIG. 19. In the thin film magnetic head 201, a low-thermal expansion material layer 252 is directly laminated on an upper return yoke 247, whose thermal expansion coefficient is great and which highly influences recording characteristics, so that an effect of preventing said projection can be improved. However, a thickness of the low-thermal expansion material layer must be thick, e.g., 1-3 μm. Therefore, if the low-thermal expansion material layer is formed on the upper return yoke 247 having a step-shaped part, etching-residua or affected parts 260 are formed, so the magnetic head will have an abnormal configuration or the affected parts 260 will separate from the magnetic head and damage a storage medium.

To solve the problems, a modified method, in which a magnetic layer connection layer is formed after forming an upper coil layer and the upper return yoke is formed after flattening an upper surface, has been proposed, but number of production steps must be significantly increased, e.g., about 50 steps increased. Further, the problem caused by the step-shaped part of the upper return yoke cannot be solved by the modified method.

### SUMMARY OF THE INVENTION

The present invention was conceived to solve the above described problems.

An object of the present invention is to provide a suitable method of producing a thin film magnetic head, which is capable of flattening a surface including an upper face of an upper return yoke without increasing production steps and forming a low-thermal expansion material layer having no step-shaped part on the flattened surface.

To achieve the object, the present invention has following constitutions.

Namely, the method of producing a thin film magnetic head comprises the steps of: forming a recording head section by laminating thin films on a substrate; forming an air bearing surface in one surface of the recording head section, which is perpendicular to surfaces of the laminated thin films; forming a coil layer, which has a planar spiral shape, on a base body of the recording head section; forming a first insulating layer on a coil wire of the coil layer and in a space defined by the coil wire other than a center part of the coil layer; forming an upper return yoke on the first insulating layer, the upper return yoke being extended from the air bearing surface to at least a part of the coil layer located on the opposite side of the air bearing surface with respect to the center part thereof; forming a second insulating layer on the upper return yoke and the first insulating layer; flattening an upper face of the upper return yoke and an upper face of the second insulating layer so as to make the both faces as a continuous flat surface; and forming a low-thermal expansion material layer on the continuous flat surface by sputtering.

Preferably, the upper return yoke is formed by plating, and a minimum height of the upper return yoke, with respect to an upper face of the base body, is equal to or higher than a height of the flat surface, which will be formed in the flattening step.

Preferably, the upper return yoke is formed by plating, and a minimum height of the upper return yoke, with respect to an upper face of the base body, is substantially equal to a height of the flat surface, which will be formed in the flattening step.

Preferably, the minimum height of the upper return yoke is the minimum height of a part of the upper return yoke which corresponds to the center part of the coil layer.

Preferably, the upper return yoke is formed by the steps of: forming a first upper return yoke layer on the first insulating layer and the base body by plating; forming a mask layer on a part of the first upper return yoke layer, which is located on the air bearing surface side with respect to the coil layer; forming a second upper return yoke layer on the first upper return yoke layer by plating; and removing the mask layer.

By employing the method of the present invention, the continuous surface including the upper face of the upper return yoke can be flattened, and the low-thermal expansion material layer having no step-shaped part can be formed on the continuous flat surface.

### BRIEF DESCRIPTION OF THE DRAWINGS

Embodiments of the present invention will now be described by way of examples and with reference to the accompanying drawings, in which:

FIG. 1 is a schematic view a thin film magnetic head produced by the method of the present invention;

FIGS. 2A and 2B are explanation views showing production steps of a first embodiment of the present invention;

FIGS. 3A and 3B are explanation views showing production steps of the first embodiment of the present invention;

FIGS. 4A and 4B are explanation views showing production steps of the first embodiment of the present invention;

FIGS. 5A and 5B are explanation views showing production steps of the first embodiment of the present invention;

FIGS. 6A and 6B are explanation views showing production steps of the first embodiment of the present invention;

FIG. 7 is an explanation view showing production steps of the first embodiment of the present invention;

FIG. 8 is a schematic plan view of the thin film magnetic head shown in FIG. 1;

FIGS. 9A and 9B are explanation views showing production steps of a second embodiment of the present invention;

FIGS. 10A and 10B are explanation views showing production steps of the second embodiment of the present invention;

FIG. 11 is an explanation view showing production steps of the second embodiment of the present invention;

FIGS. 12A and 12B are explanation views showing production steps of a third embodiment of the present invention;

FIGS. 13A and 13B are explanation views showing production steps of the third embodiment of the present invention;

FIGS. 14A and 14B are explanation views showing production steps of the third embodiment of the present invention;

FIGS. 15A and 15B are explanation views showing production steps of the third embodiment of the present invention;

FIGS. 16A and 16B are explanation views showing production steps of the third embodiment of the present invention, wherein a modified upper return yoke is used;

FIG. 17 is an explanation view showing production steps of the third embodiment of the present invention, wherein the modified upper return yoke is used;

FIG. 18 is a schematic view of the conventional thin film magnetic head; and

FIG. 19 is a schematic view of another conventional thin film magnetic head.

### DETAILED DESCRIPTION OF THE EMBODIMENTS

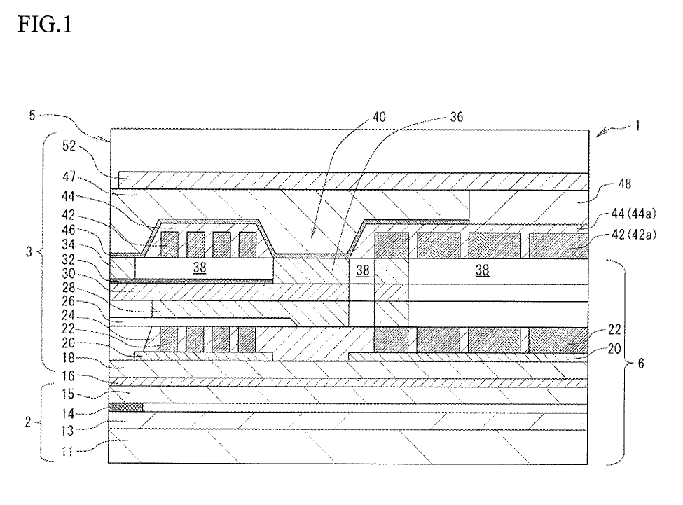

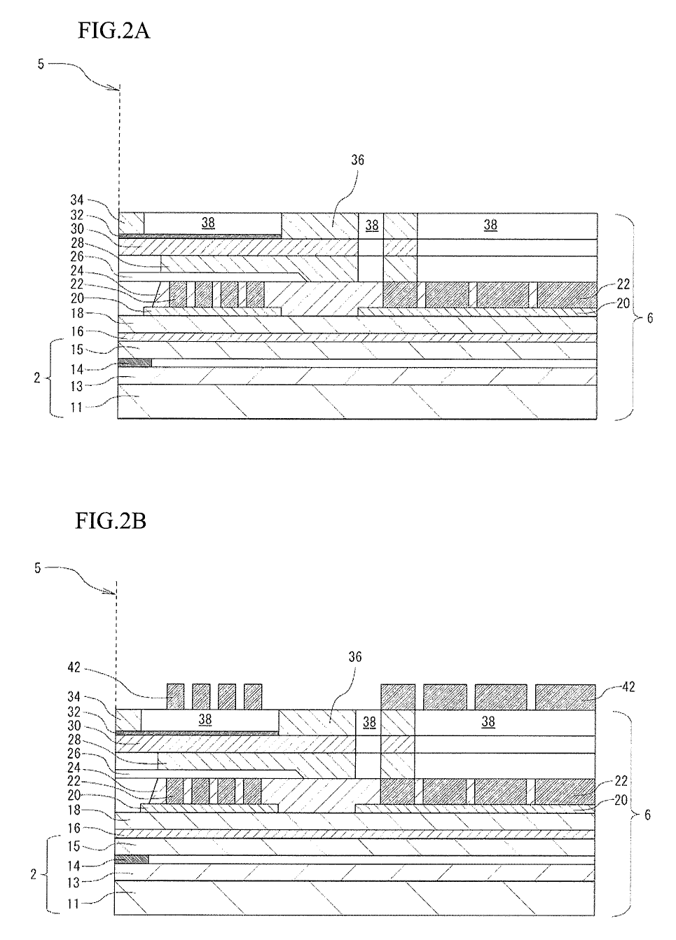

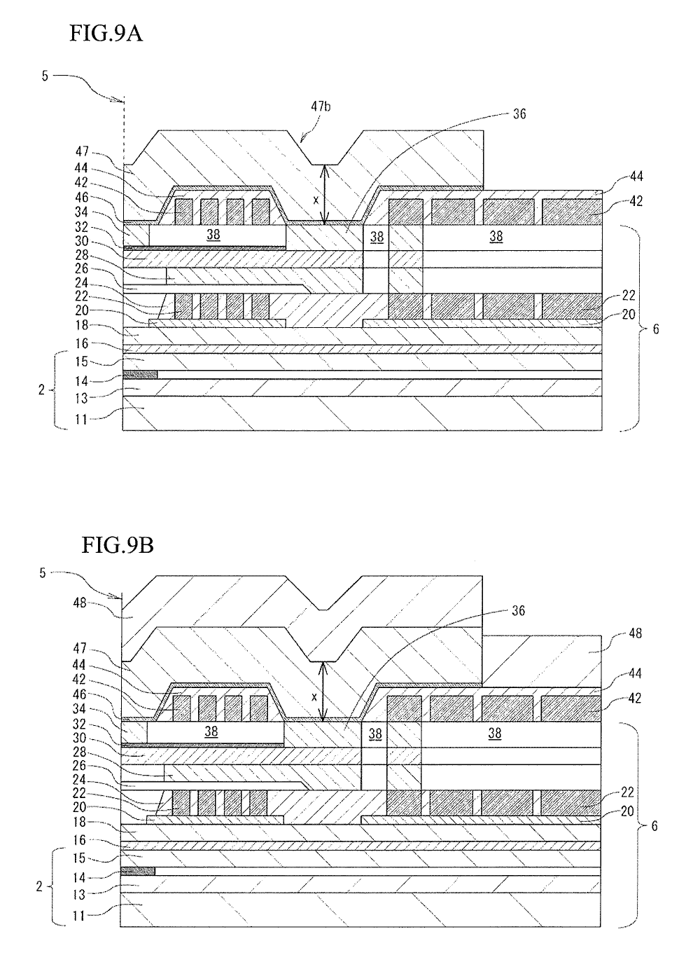

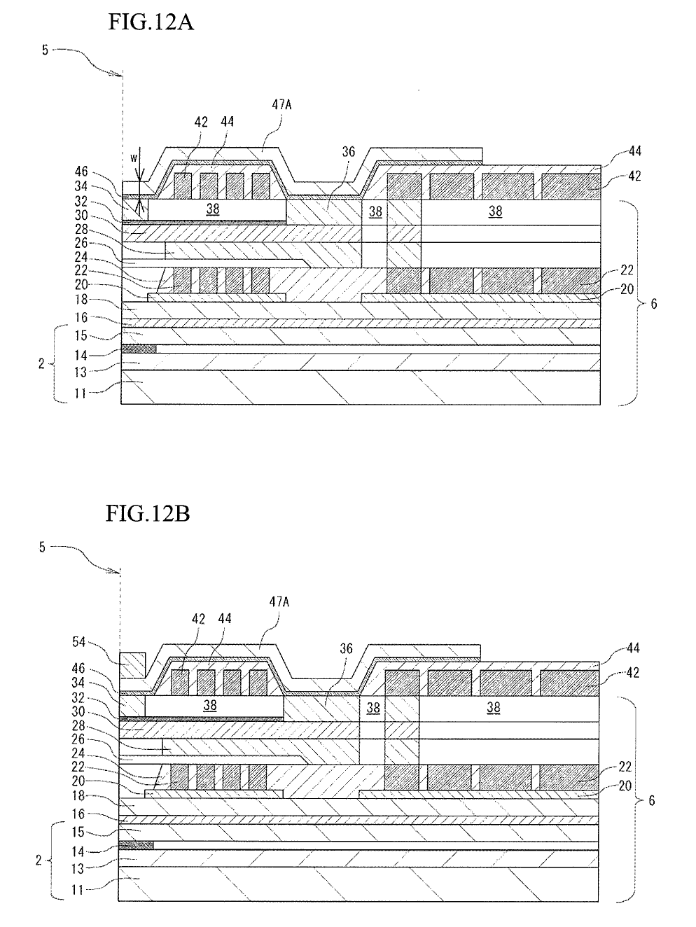

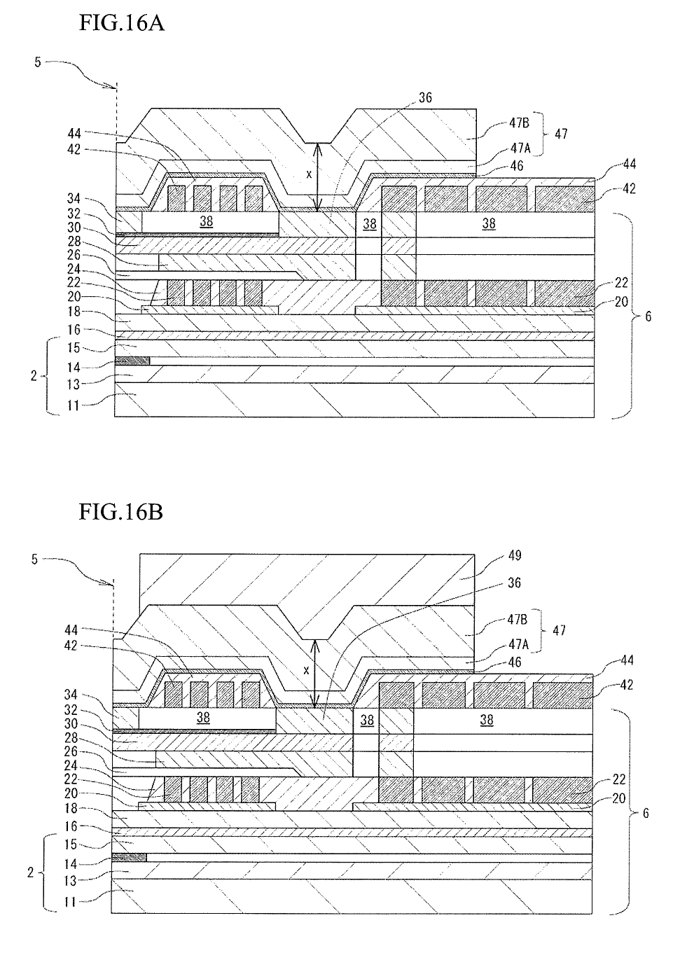

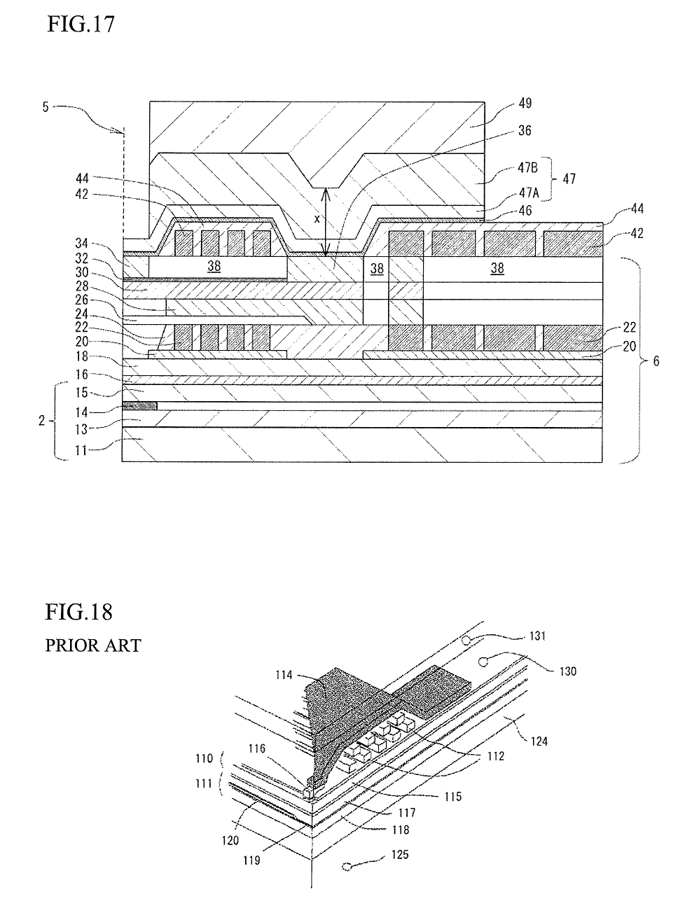

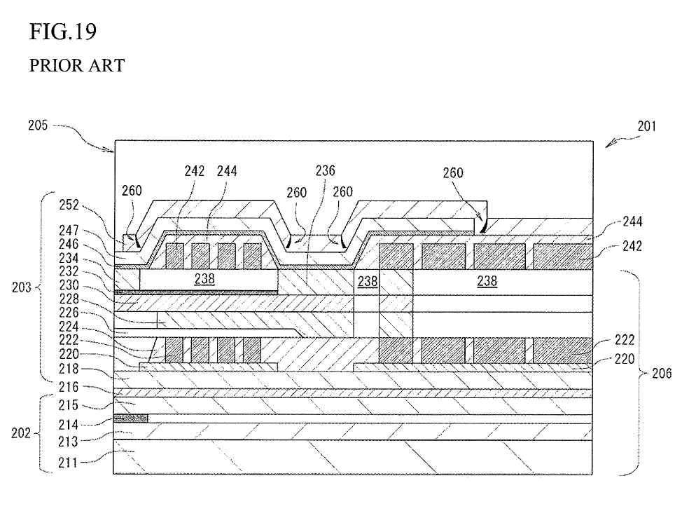

Preferred embodiments of the present invention will now be described in detail with reference to the accompanying drawings, in which: FIG. 1 is a schematic view a thin film magnetic head produced by the method of the present invention; FIGS. 2A-7 are explanation views showing production steps of a first embodiment of the present invention; FIG. 8 is a schematic plan view of the thin film magnetic head shown in FIG. 1, which is seen in the direction from an upper face of a low-thermal expansion material layer 52 to a substrate 11; FIGS. 9A-11 are explanation views showing production steps of a second embodiment of the present invention; FIGS. 12A-15B are explanation views showing production steps of a third embodiment of the present invention; and FIGS. 16A and 16B are explanation views showing production steps of the third embodiment of the present invention, wherein a modified upper return yoke 47 is used; and FIG. 17 is an explanation view showing production steps of the third embodiment of the present invention, wherein the modified upper return yoke 47 is used.

The thin film magnetic head 1 relating to the present invention has a recording head section 3 for writing magnetic signals on a magnetic storage medium, e.g., hard disk.

The recording head section 3 is formed by laminating thin films, and an air bearing surface 5 is formed in one side surface of the recording head section 3, which is perpendicular to surfaces of the laminated thin films so as to form a head slider. The head slider of the air bearing surface 5 is floated from a surface of the magnetic storage medium and writes magnetic signals on the magnetic storage medium rotated.

The structure of the thin film magnetic head 1 will be explained. Note that, vertical magnetic recording heads will be explained as examples of the thin film magnetic head in the following embodiments, but the present invention is not limited to the embodiments.

Firstly, a first embodiment will be explained.

For example, the thin film magnetic head 1 is constituted by a reproducing head section 2 and the recording head section 3 as shown in FIG. 1. Generally, the air bearing surface 5 is formed, by an abrasive process after completing a laminating step to be described. Therefore, in a narrow sense, the air bearing surface 5 should be considered as a planned place of the air bearing surface. In the drawings, layers which are not hatched and to which no symbols are assigned are insulating layers composed of, for example, Al₂O₃.

For example, the reproducing head section 2 is formed by laminating a lower shielding layer 13, a magnetoresistance effect reproducing element 14 and an upper shielding layer 15 on a substrate 11. The substrate 11 is composed of an insulating material, e.g., Al₂O₃—TiC.

A TMR element or a GMR element is uses as the magnetoresistance effect reproducing element 14. TMR elements or GMR elements having various types of film structures may be used.

The lower shielding layer 13 is composed of a soft magnetic material, e.g., permalloy. The upper shielding layer 15 is composed of a soft magnetic material, e.g., permalloy, as well as the lower shielding layer 13.

In the present embodiment, a magnetism separation layer 16, which is composed of an insulating material, is formed on the upper shielding layer 15, and the recording head section 3 is formed thereon.

The recording head section 3 has a lower return yoke 18, which is composed of a magnetic material, e.g., permalloy. A lower insulating layer 20 is formed on the lower return yoke 18. The lower insulating layer 20 is composed of an insulating material, e.g., Al₂O₃.

Note that, a DFH heater (not shown) may be provided in the lower insulating layer 20 so as to control a length of projecting the recording head section 3 toward the air bearing surface 5.

A lower coil layer 22, which has a planar spiral shape, is composed of an electrically conductive material, e.g., copper, and formed on the lower insulating layer 20.

A lower coil insulating layer 24 is formed on a coil wire of the lower coil layer 22 and in a space defined by the coil wire. The lower coil insulating layer 24 is composed of an insulating material, e.g., Al₂O₃.

An auxiliary magnetic pole 28 is formed on the lower coil layer 22 and the lower coil insulating layer 24, and an insulating layer 26 is partially provided between the auxiliary magnetic pole 28 and the layers 22 and 24. The auxiliary magnetic pole 28 is composed of a magnetic material, e.g., permalloy; the insulating layer 26 is composed of an insulating material, e.g., Al₂O₃.

A main magnetic pole 30 is formed on the auxiliary magnetic pole 28 and composed of a magnetic material, e.g., permalloy.

A trailing gap 32 and a connecting section 36 are formed on the main magnetic pole 30. A trailing shield 34 is formed on a part of the trailing gap 32. The trailing gap 32 is composed of an insulating material, e.g., Al₂O₃; the trailing shield 34 and the connecting section 36 are composed of magnetic materials, e.g., permalloy.

Peripheries of the trailing shield 34 and the connecting section 36 are filled with an insulating layer 38, which is composed of an insulating material, e.g., Al₂O₃. In the present production step, upper faces of the trailing shield 34, the connecting section 36 and the insulating layer 38 are flattened and included in the same plane.

In the present embodiment, a block including a laminated body from the substrate 11 to the trailing shield 34, the connecting section 36 and the insulating layer 38 is called a base body 6.

Note that, the layered structure of the base body 6 is not limited to the present embodiment. Various layered structures may be employed.

An upper coil layer 42, which has a planar spiral shape and which is composed of an electrically conductive material, e.g., copper, is formed on the base body 6.

An upper insulating layer 44 is formed on a coil wire of the upper coil layer 42 and in a space defined by the coil wire other than a center part 40 of the spiral. The upper insulating layer 44 is composed of an insulating material, e.g., resist.

An upper return yoke 47 is formed on the upper insulating layer 44 and a part of the base body 6 which is not covered with the insulating layer 44. The upper return yoke 47 is composed of a magnetic material, e.g., permalloy. The upper return yoke 47 is extended from the air bearing surface 5 to at least a part of the upper coil layer 42 located on the opposite side of the air bearing surface with respect to the center part 40 thereof (i.e., a mid part of the upper insulating layer 44a on the opposite side of the air bearing surface 5 with respect to the center part 40). In the present embodiment, the upper return yoke 47 is extended, in the height direction perpendicular to the air bearing surface 5, until reaching a mid part of the upper coil layer 42 located on the opposite side 42a of the air bearing surface 5 with respect to the center part 40. Note that, the present invention is not limited to the above described structure. For example, the upper return yoke 47 may be extended to cover a part of the upper coil layer 42 on the opposite side 42a and may be extended to cover the entire upper coil layer 42.

An insulating layer 48, which is composed of an insulating material, e.g., Al₂O₃, is formed on a part of the upper insulating layer 44 which is not covered with the upper return yoke 47. Further, a low-thermal expansion material layer 52 is layered on the upper return yoke 47 and the insulating layer 48. Details of this part will be explained later.

Next, a method of producing the thin film magnetic head 1 will be explained with reference to the drawings.

In the method, firstly the reproducing head section 2 is formed, and then the magnetism separation layer 16 is formed thereon. The recording head section 3 is formed on the magnetism separation layer 16. Unique production steps of the present embodiment will be explained.

In FIG. 2A, the base body 6, which includes the trailing shield 34, the connecting section 34, the insulating layer 38, etc., is formed, and then the upper faces of the trailing shield 34, the connecting section 34 and the insulating layer 38 are flattened, by a lapping tool, to form into a continuous flat surface.

In FIG. 2B, the upper coil layer 42 is formed on the base body 6 by electrolytic plating.

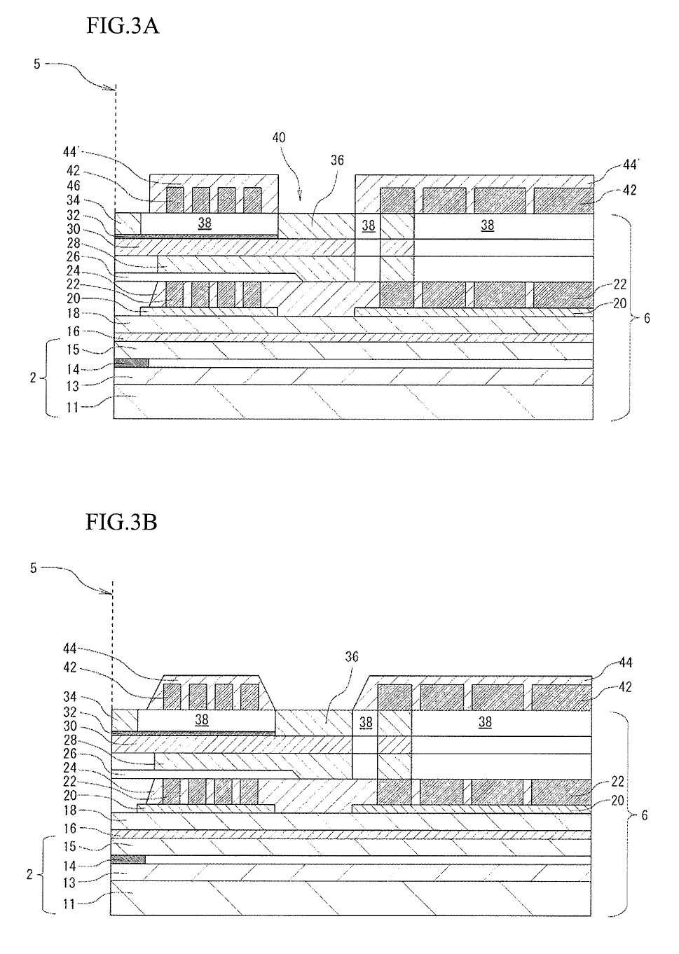

In FIG. 3A, an upper insulating layer 44′ composed of resist is formed on the coil wire of the upper coil layer 42 and in the space defined by the coil wire other than the center part 40. Then, the upper insulating layer 44′ is hard-baked so as to form the upper insulating layer 44.

A time length of the hard-baking step depends on quality, thickness, etc. of the resist. For example, the hard-baking step is performed for several hours at high temperature, e.g., 200° C. or more. By performing the hard-baking step, an end of the upper insulating layer 44′ is shrunk and deformed by heat, so that the upper insulating layer 44, whose sectional shape is a hog-backed shape, can be formed (see FIG. 3B). The sectional shape of the upper insulating layer 44 depends on quality of the resist, an initial shape and conditions of the hard-baking process.

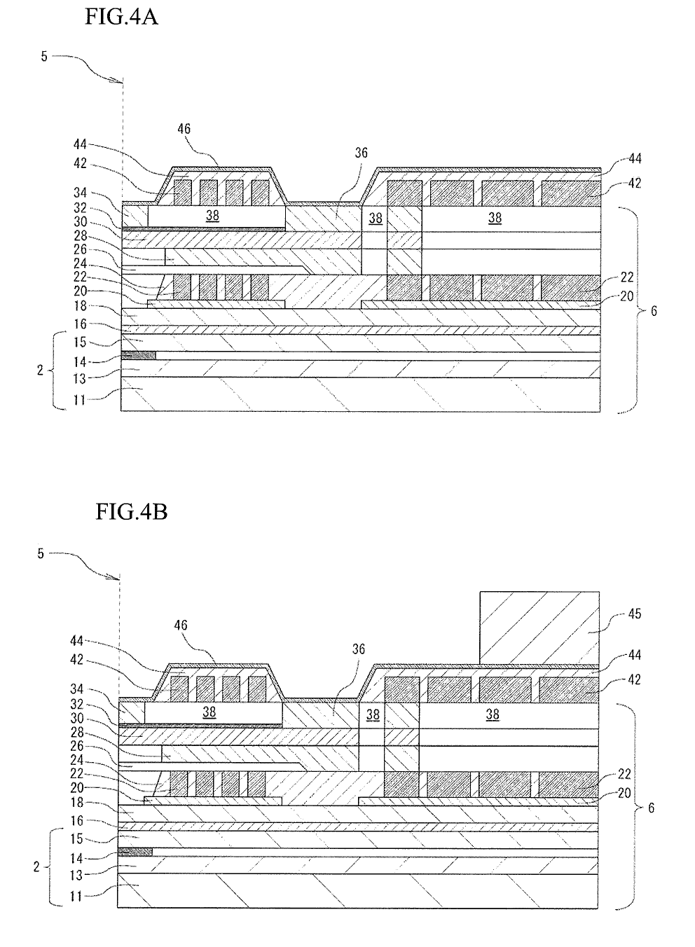

Next, a plating base 46 is formed on the entire surface as shown in FIG. 4A, and then a mask layer 45 is formed on a part of the plating base 46, which will not be covered with the upper return yoke 47, as shown in FIG. 4B.

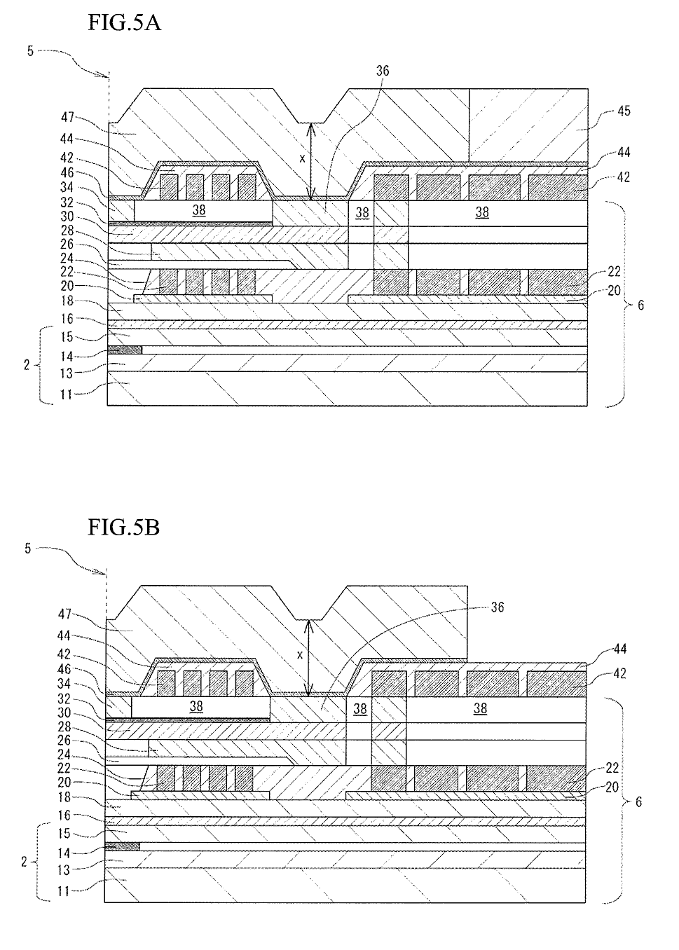

The upper return yoke 47 is formed on the plating base 46 by plating as shown in FIG. 5A, and then the mask layer 45 is removed and disuses parts of the plating base 46 are removed, by ion milling, as shown in FIG. 5B.

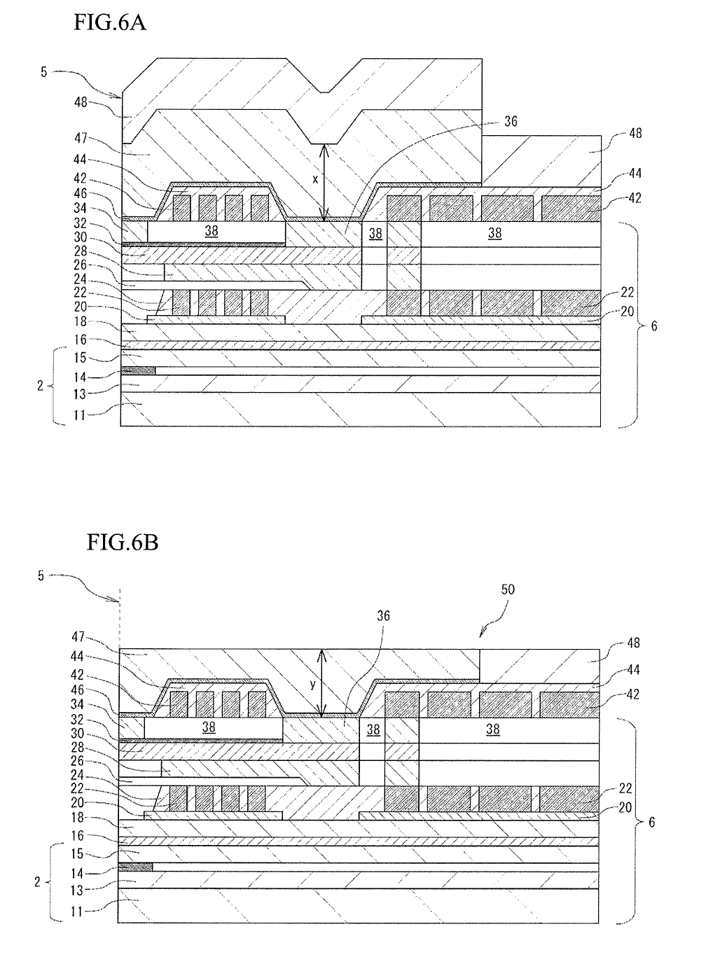

The unique feature of the first embodiment will be explained. A minimum height “x” of the plated upper return yoke 47 (see FIG. 6A) with respect to the upper face of the base body 6, i.e., standard surface, is equal to or higher than a height “y” of a flat surface, which will be formed in the flattening step. Namely, x≧y.

The minimum height “x” is the minimum height of a part of the upper return yoke 47 which corresponds to the center part 40 of the upper coil layer 42. If the upper face of the base body 6 is flat, the height of the standard surface is even at every position, so the minimum height “x” can be determined. However, as described above, the base body 6 may have other structures. If the upper face of the base body 6 is not flat, the minimum height will be observed at a position close to the air bearing surface 5, at a position in the opposite part of the air bearing surface 5, etc. Therefore, the minimum height “x” is defined as “the minimum height of the part of the upper return yoke 47 corresponding to the center part 40 of the upper coil layer 42”.

Next, the upper return yoke 47 and the insulating layer 48 composed of Al₂O₃ are formed on the base body 6 by sputtering (see FIG. 6A). Note that, the insulating layer 48 is formed on the part of the upper insulating layer 44 which is not covered with the upper return yoke 47.

The upper faces of the insulating layer 48 and the upper return yoke 47 are abraded by a chemical mechanical polishing (CMP) method as shown in FIG. 6B. In FIG. 6B, the upper face of the upper return yoke 47 is flattened until the height of the upper face of the upper return yoke 47 with respect to the upper face of the base body 6 reaches “y”. With this process, the upper faces of the upper return yoke 47 and the insulating layer 48 are formed into a continuous flat surface 50.

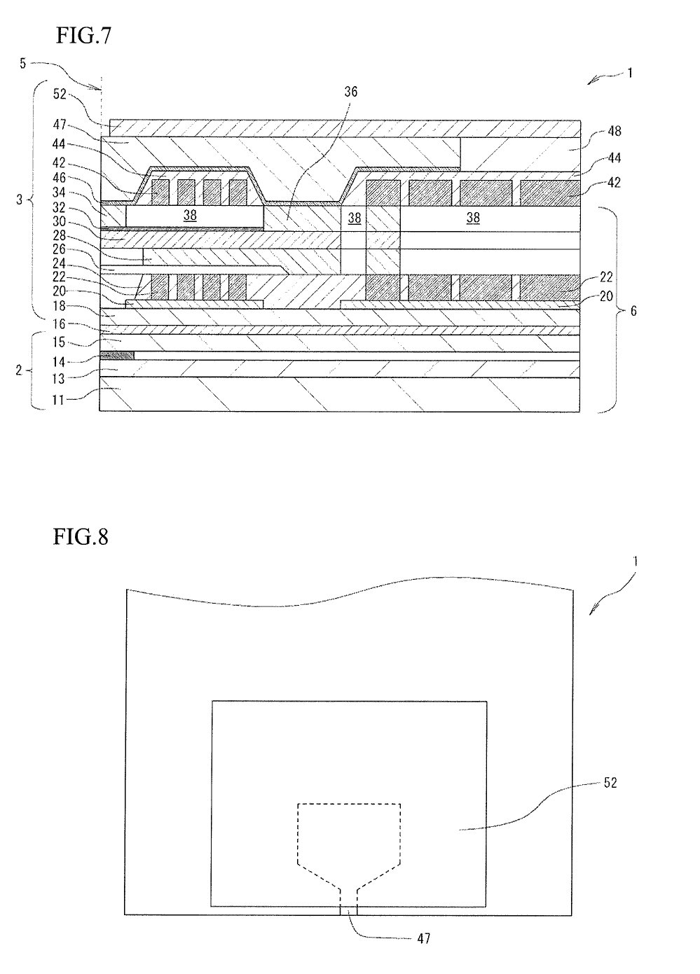

Next, the low-thermal expansion material layer 52 is formed on the flat surface 50 as shown in FIG. 7. Note that, a plan view of the thin film magnetic head 1, in which the low-thermal expansion material layer 52 has been formed, is shown in FIG. 8, in which the thin film magnetic head 1 is seen in the direction from the upper face of the low-thermal expansion material layer 52 to the substrate 11.

Preferably, the low-thermal expansion material layer 52 is composed of an insulating material whose thermal expansion coefficient is smaller than that of Al₂O₃. For example, SiC, Si₃N₄, SiO₂, AlN, Al₃S₄, W, etc. may be employed as the insulating material.

By forming the low-thermal expansion material layer 52, the projection of the recording head section 3 (especially the upper return yoke 47) toward the storage medium, which is caused by rise of temperature, can be prevented. In case of using the DFH heater for controlling the projection of the recording head section 3, a standard position of the projection can be securely maintained at a predetermined position, so that an amount of the projection can be precisely controlled. Therefore, recording and reproducing accuracies (especially recording accuracy) can be improved and stabilized, and colliding the thin film magnetic head 1 (especially the recording head section 3) with the storage medium can be prevented.

In the present embodiment, the low-thermal expansion material layer 52 is formed on the flat surface 50 by sputtering, so the homogenous low-thermal expansion material layer 52 having a rectangular sectional shape can be formed without forming a step-shaped part.

As described above, if a step-shaped part exists in the low-thermal expansion material layer 52 formed by sputtering, the step-shaped part will be an affected part. By employing the method of the present embodiment, no step-shaped part is formed in the low-thermal expansion material layer 52, so that the problem of forming the affected part can be solved.

Further, the low-thermal expansion material layer 52 bonded to the entire upper face of the upper return yoke 47, so that the projection of the upper return yoke 47, which is caused by rise of temperature, can be securely prevented.

The thin film magnetic head 1 is produced by the above described steps.

Successively, a second embodiment will be explained.

In the second embodiment, the steps shown in FIGS. 2A-4B are performed as well as the first embodiment. Namely, the plating base 46 is formed on the entire surface, and then the mask layer 45 composed of resist is formed on the part of the plating base 46, which will not be covered with the upper return yoke 47.

The second embodiment is characterized by the step of forming the upper return yoke 47 having a prescribed thickness by electrolytic plating.

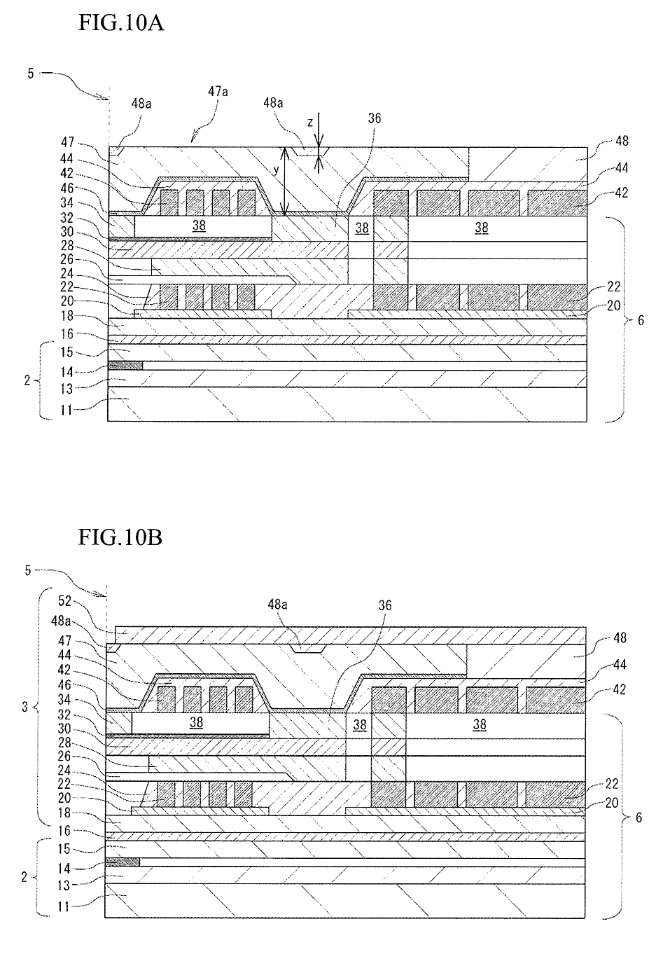

Namely, a height of the plated upper return yoke 47 and a method of flattening the same are different from the first embodiment. The present embodiment is characterized in that the minimum height “x” of the plated upper return yoke 47 with respect to the upper face of the base body 6, i.e., standard surface, is substantially equal to the height “y” of the flat surface, which will be formed in the flattening step (see FIG. 10A). Next, the resist mask layer 45 is removed, and disused parts of the plating base 46 are removed by ion milling (see FIG. 9A). Note that, the case of x>y has been explained in the first embodiment, so a case of x<y will be explained.

After completing the plating step, the insulating layer 48 is formed as well as the first embodiment (see FIG. 9B), and then the flattening step is performed by the CMP method and the low-thermal expansion material layer 52 is formed on the flat surface. In case of x<y, if the upper face of the insulating layer 48 is abraded by the CMP method, the upper face 47a of the upper return yoke 47 can be flattened as shown in FIG. 10A, but residual parts 48a of the insulating layer 48, which have inverted conical shapes or inverted semi-conical shapes, are formed in the upper face of the upper return yoke 47.

In case that the height “x” is substantially equal to the height “y”, the residual parts 48a can be fine, so that the effects of the first embodiment can be obtained in the second embodiment too. In other words, if the sizes of the residual parts 48a are increased, a contact area between the low-thermal expansion material layer 52 to be formed and the upper return yoke 47 is reduced, so a force restraining the projection of the upper return yoke 47 will be reduced.

Therefore, a suitable height “z” of the residual part 48a, i.e., x-y, depending on a shape of the upper face 47a of the plated upper return yoke 47 (see FIG. 9A), is 1 μm or less.

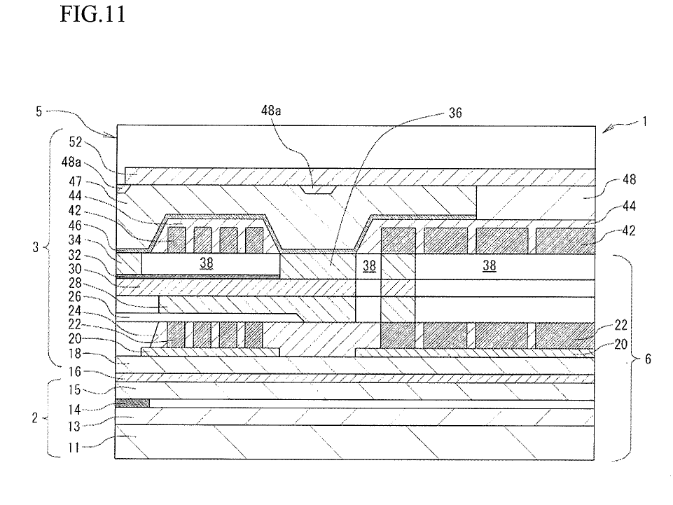

The thin film magnetic head 1 shown in FIG. 11 can be produced by the above described steps.

Successively, a third embodiment will be explained.

In the third embodiment, the steps shown in FIGS. 2A-4B are performed as well as the first embodiment. Namely, the plating base 46 is formed on the entire surface, and then the mask layer 45 composed of resist is formed on the part of the plating base 46, which will not be covered with the upper return yoke 47.

The third embodiment is characterized by the step of forming the upper return yoke 47 having a prescribed thickness by electrolytic plating.

Unlike the first embodiment, the plating step is divided into two steps in the third embodiment. Firstly, as shown in FIG. 12A, a first upper return yoke layer 47A is formed on the plating base 46, by electrolytic plating, until reaching a prescribed thickness. For example, a thickness of a part of the first upper return yoke layer 47A, which is close to the air bearing surface 5, with respect to the upper face of the base body 6, i.e., standard surface, is a prescribed thickness “w”.

Next, as shown in FIG. 12B, a resist mask layer 54 is formed on a part of the first upper return yoke layer 47A which is located on the air bearing surface 5 side of the upper coil layer 42.

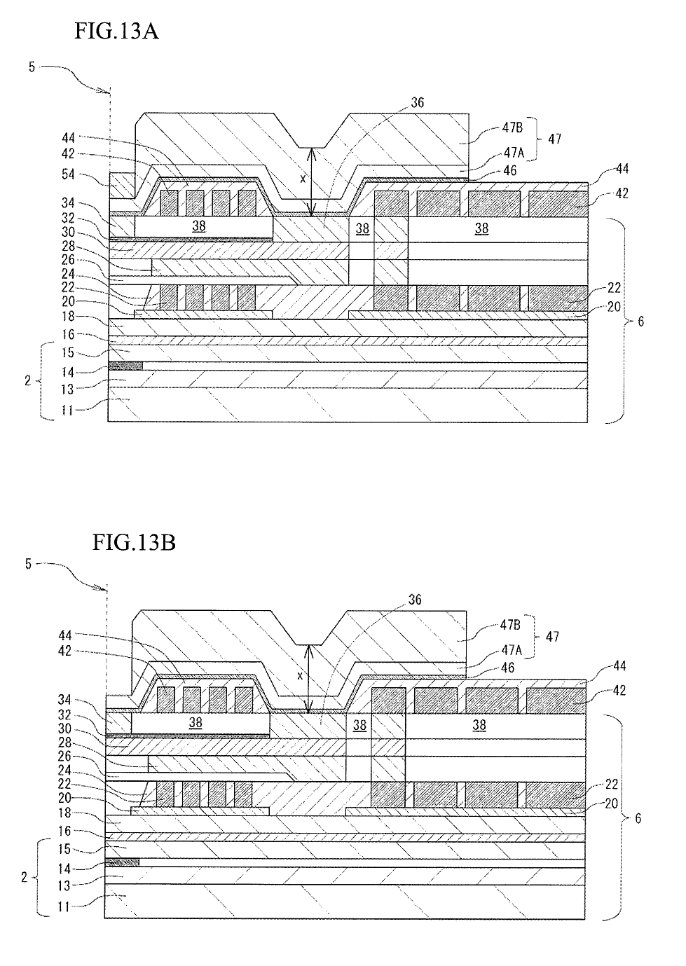

Next, as shown in FIG. 13A, a second upper return yoke layer 47B is formed on the first upper return yoke layer 47A, by electrolytic plating, until reaching a prescribed thickness. Note that, a plating base is firstly formed, and then the second upper return yoke layer 47B is formed. Disused parts of the plating base are removed in the following step (not shown).

Next, as shown in FIG. 13B the resist mask layer 54 is removed.

Successively, a process of forming a modified upper return yoke 47 will be explained. The first upper return yoke layer 47A having the thickness “w” is formed by electrolytic plating (see FIG. 12A), and then the second upper return yoke layer 47B having the prescribed thickness is formed on the first upper return yoke layer 47A, by electrolytic plating, as shown in FIG. 16A. Note that, the steps of forming the plating bases and the steps of removing them are not shown.

Next, as shown in FIG. 16B, a resist mask layer 49 is formed on a specific area, in which the second upper return yoke layer 47B will be left.

Next, as shown in FIG. 17, the second upper return yoke layer 47B other than the specific area covered with the mask layer 49 is removed by ion milling, so that the first upper return yoke layer 47A having the thickness “w” is partially exposed.

Next, the resist mask layer 49 is removed by ion milling, so that the structure shown in FIG. 13B can be formed.

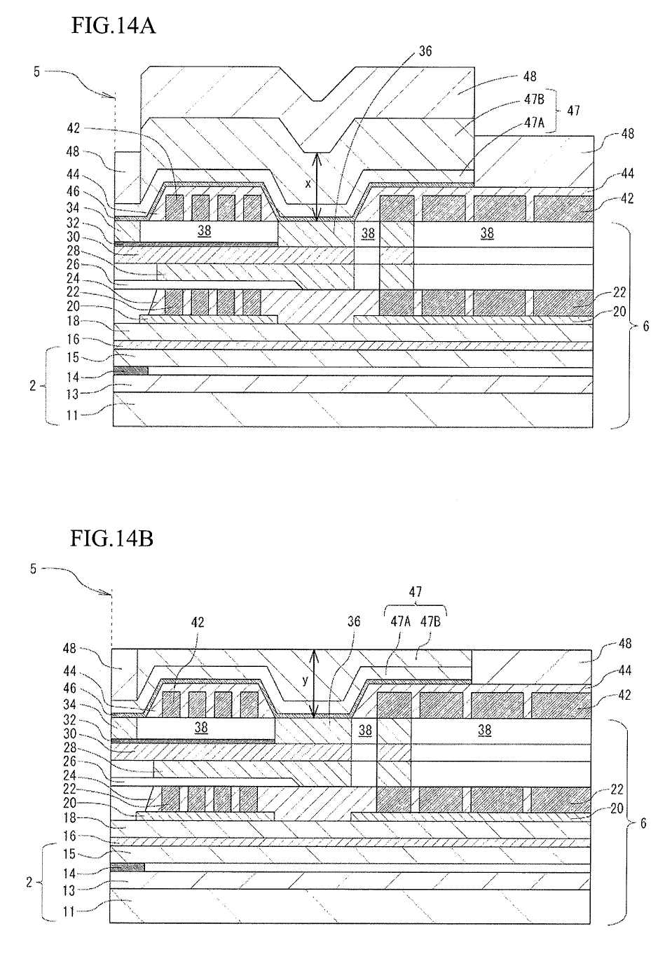

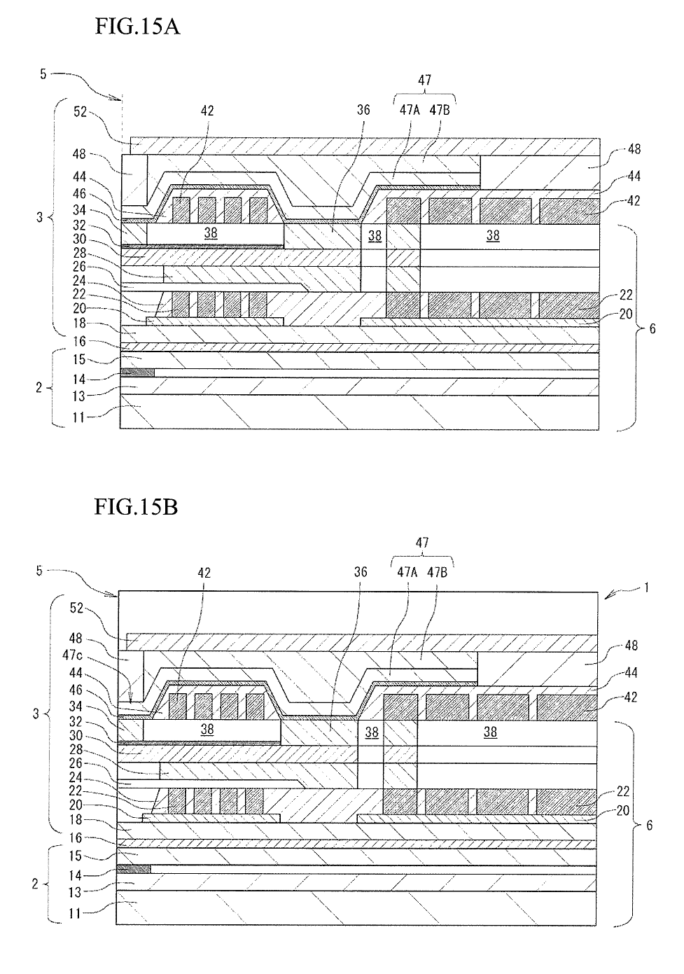

After forming the upper return yoke 47 is formed, the insulating layer 48 is formed (see FIG. 14A) as well as the first embodiment. Further, the flattening step (see FIG. 14B) and the step of forming the low-thermal expansion material layer 52 (see FIG. 15A) are performed. If x≧y, no residual parts of the insulating layer 48 are formed in the upper face 47a of the upper return yoke 47 as well as the first embodiment. If x<y or x is substantially equal to y, residual parts of the insulating layer 48 will be formed in the upper face 47a of the upper return yoke 47 as well as the second embodiment.

In the third embodiment, the upper return yoke 47 has the shape shown in FIG. 15B. Namely, a front end 47c of the upper return yoke 47 can have a desired thickness, and the front end 47c can be suitably shaped according to required recording characteristics.

The thin film magnetic head 1 shown in FIG. 15B can be produced by the above described steps.

Each of the methods of the above described embodiments is capable of forming the flat surface including the upper face of the upper return yoke and forming the low-thermal expansion material layer on the flat surface without forming step-shaped parts. Therefore, the projection of the magnetic head can be highly prevented by the low-thermal expansion material layer, so that recording characteristics can be highly improved. Further, forming etching-residua and affected parts can be prevented by the low-thermal expansion material layer, so that occurrence of an abnormal configuration of the magnetic head and damaging the storage medium caused by separated affected parts can be prevented.

In comparison with the conventional method, increase of production steps can be limited to about 20.

Note that, the vertical magnetic recording heads have been explained in the above described embodiments, but the present invention is not limited to the embodiments.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing a thin film magnetic head,
comprising the steps of:
forming a recording head section by laminating thin films on a substrate;
forming an air bearing surface in one surface of the recording head section, which is perpendicular to surfaces of the laminated thin films;
forming a coil layer, which has a planar spiral shape, on a base body of the recording head section;
forming a first insulating layer on a coil wire of the coil layer and in a space defined by the coil wire other than a center part of the coil layer;
forming an upper return yoke on the first insulating layer, the upper return yoke being extended from the air bearing surface to at least a part of the coil layer located on the opposite side of the air bearing surface with respect to the center part thereof;
forming a second insulating layer on the upper return yoke and the first insulating layer;
flattening an upper face of the upper return yoke and an upper face of the second insulating layer so as to make the both faces as a continuous flat surface; and
forming a low-thermal expansion material layer on the continuous flat surface by sputtering.

2. The method according to claim 1,
wherein the upper return yoke is formed by plating, and
a minimum height of the upper return yoke, with respect to an upper face of the base body, is equal to or higher than a height of the flat surface, which will be formed in the flattening step.

3. The method according to claim 1,
wherein the upper return yoke is formed by plating, and
a minimum height of the upper return yoke, with respect to an upper face of the base body, is substantially equal to a height of the flat surface, which will be formed in the flattening step.

4. The method according to claim 2,
wherein the minimum height of the upper return yoke is the minimum height of a part of the upper return yoke which corresponds to the center part of the coil layer.

5. The method according to claim 3,
wherein the minimum height of the upper return yoke is the minimum height of a part of the upper return yoke which corresponds to the center part of the coil layer.

6. The method according to claim 4,
wherein the upper return yoke is formed by the steps of:
forming a first upper return yoke layer on the first insulating layer and the base body by plating;
forming a mask layer on a part of the first upper return yoke layer, which is located on the air bearing surface side with respect to the coil layer;
forming a second upper return yoke layer on the first upper return yoke layer by plating; and
removing the mask layer.

7. The method according to claim 5,
wherein the upper return yoke is formed by the steps of:
forming a first upper return yoke layer on the first insulating layer and the base body by plating;
forming a mask layer on a part of the first upper return yoke layer, which is located on the air bearing surface side with respect to the coil layer;
forming a second upper return yoke layer on the first upper return yoke layer by plating; and
removing the mask layer.
